(19) United States
(12) Patent Application Publication
(10) Pub. No.: US 2025/0056273 A1
(43) Pub. Date: Feb. 13, 2025

(54) PORTABLE DEVICE FOR DETERMINING COMMUNICATION PERFORMANCE METRICS OF A CELLULAR MODULE, AND METHOD THEREOF

(71) Applicant: Aktiebolaget SKF, Göteborg (SE)

(72) Inventors: Xiaoyuan MA, Shanghai (CN); Bingliang LOU, Shanghai (CN); Xing YI, Shanghai (CN)

(21) Appl. No.: 18/781,534

(22) Filed: Jul. 23, 2024

(30) Foreign Application Priority Data
Aug. 9, 2023 (CN) 202310997096.2

(51) Int. Cl. H04W 24/08; H04W 24/02

(52) U.S. Cl. CPC H04W 24/08; H04W 24/02

(57) ABSTRACT

A portable device and method for determining communication performance metrics are provided. The portable device communicates with the cloud and includes a control device and storage. The control device records and/or processes communication-related data for determining the corresponding metric. The control device acquires communication-related data of a predetermined communication performance metric based on the configuration information, and determines and records the predetermined communication performance metric of the to-be-tested cellular module based on the communication-related data, or records the communication-related data; and uploads the predetermined communication performance metric or the communication-related data to the cloud via the to-be-tested cellular module when the data is required and able to be uploaded to the cloud. Storage stores the predetermined communication performance metric or the communication-related data when there is no need or inability to upload the data to the cloud and the storage space is not full.

### CROSS-REFERENCE TO RELATED APPLICATION

This application claims priority to Chinese Application No. 202310997096.2, filed Aug. 9, 2023, the entirety of which is hereby incorporated by reference.

### FIELD

The present application relates to a field of communication, and more particularly, to a portable device for determining communication performance metrics of a cellular module and a method for determining communication performance metrics of a cellular module performed by a portable device.

### BACKGROUND

Internet of Things (IoT) or Industrial Internet of Things (IIoT) products, such as wireless sensors, typically require high reliability and high certainty, so accurately and quantitatively evaluating each component in these products will facilitate design and optimization. A communication module is typically provided on these products to enable information exchange with the cloud (e.g., uploading sensory data to the cloud). A cellular module (containing a corresponding Subscriber Identity Identification (SIM) card), as one of the most common communication modules, may include but is not limited to, for example, a Narrowband Internet of Things (NB-IoT) communication module, as well as a Long Term Evolution (LTE) Catl communication module, etc., whose various communication performance metrics may differ significantly in different application scenarios due to a variety of factors (e.g., coverage, manufacturer, operator, or reconnection, etc.).

Therefore, monitoring and evaluation of the communication performance metrics (e.g., energy consumption, end-to-end reliability, communication latency or other customized communication metrics, etc.) of the cellular module in different application scenarios becomes very important, which places new demands on a portability of evaluation tools, and therefore, there is a need for an apparatus with portability for monitoring and evaluating the communication performance metrics of the cellular module.

### SUMMARY

According to an aspect of the present application, there is provided a portable device for determining communication performance metrics of a cellular module, where the portable device has an ability to communicate with cloud and is configured to either communicate with the cloud or not communicate with the cloud under different scenarios, the portable device comprising: a control device having an ability to monitor, record and/or process communication-related data respectively associated with a plurality of types of communication performance metrics for determining respective communication performance metrics, and is configured to: determine, based on configuration information, a type of a predetermined communication performance metric and identification information of a to-be-tested cellular module; acquire, based on the type and the identification information, communication-related data of the to-be-tested cellular module for determining the predetermined communication performance metric, and determine and record the predetermined communication performance metric of the to-be-tested cellular module based on the communication-related data, or record the communication-related data for determining the predetermined communication performance metric; and upload, via the to-be-tested cellular module and to the cloud, the predetermined communication performance metric or the communication-related data for determining the predetermined communication performance metric, in a case where data is required and able to be uploaded to the cloud; and a storage for storing the predetermined communication performance metric or the communication-related data for determining the predetermined communication performance metric, in a case where data is not required or unable to be uploaded to the cloud and storage space of the storage is not full.

According to another aspect of the present application, there is also provided a method for determining communication performance metrics of a cellular module using a portable device, where the portable device has an ability to communicate with cloud and is configured to either communicate with the cloud or not communicate with the cloud under different scenarios and has an ability to monitor, record and/or process communication-related data respectively associated with a plurality of types of communication performance metrics for determining respective communication performance metrics, the method comprising: determining, based on configuration information, a type of a predetermined communication performance metric for a to-be-tested cellular module and identification information of the to-be-tested cellular module; acquiring, based on the type and the identification information, communication-related data of the to-be-tested cellular module for determining the predetermined communication performance metric, and determining and recording the predetermined communication performance metric of the to-be-tested cellular module based on the communication-related data, or recording the communication-related data for determining the predetermined communication performance metric; and uploading, via the to-be-tested cellular module and to the cloud, the predetermined communication performance metric or the communication-related data for determining the predetermined communication performance metric, in a case where data is required and able to be uploaded to the cloud; and storing the predetermined communication performance metric or the communication-related data for determining the predetermined communication performance metric, in a case where data is not required or unable to be uploaded to the cloud and storage space of a storage is not full.

In accordance with another aspect of the present application, a system for monitoring and evaluating communication performance metrics is also provided. The system may include: one or more to-be-tested cellular modules; a portable device as previously described for determining the communication performance metric of each of the one or more to-be-tested cellular modules; and cloud for data communication with the portable device via one of the one or more to-be-tested cellular modules.

In the solution of the present disclosure, a portable device (monitor) may automatically determine (e.g., monitor and evaluate, process, calculate or obtain, among other operations) and record various communication performance metrics of a cellular module or communication-related data for determining the communication performance metrics. In addition, since data of the communication performance metrics or the communication-related data can be uploaded to the cloud, requirements on a storage space of storage and processing ability of a control device in the monitor can be reduced to some extent. Furthermore, the portable device (monitor) can be implemented with small components and is therefore small and low cost, with portability.

### BRIEF DESCRIPTION OF THE DRAWINGS

In order to more clearly illustrate the technical solutions in the embodiments of the present application or the prior art, the following will simply introduce the accompanying drawings which are needed in the description of the embodiments of the present application or the prior art, and it is obvious that the accompanying drawings in the following description are only some of the embodiments described in the present application, and other drawings can be obtained by those skilled in the art according to these drawings of the embodiments of the present application.

FIG. 1 illustrates a schematic diagram of a system for determining communication performance metrics of a cellular module according to an embodiment of the present application.

FIG. 2-FIG. 3 each show more details of the system shown in FIG. 1, in which an internal structure of the monitor is shown.

FIG. 4 illustrates a structure of a cellular interface according to an embodiment of the present application.

FIG. 5 illustrates a schematic diagram of processes of determining communication performance metrics of a to-be-tested cellular module performed by the control device 201 under Situation 1 according to an embodiment of the present application.

FIG. 6 illustrates a schematic diagram of processes of determining communication performance metrics of a to-be-tested cellular module performed by the control device 201 under Situation 2 according to an embodiment of the present application.

FIG. 7 illustrates a schematic diagram of processes of determining communication performance metrics of a to-be-tested cellular module performed by the control device 201 under Situation 3 according to an embodiment of the present application.

FIG. 8 is a flow diagram illustrating a method for monitoring and evaluating communication performance metrics according to an embodiment of the present disclosure.

### DETAILED DESCRIPTION

A clear and complete description will be made below of the technical solutions in the embodiments of the present disclosure in conjunction with the accompanying drawings in the embodiments of the present disclosure. Apparently, the described embodiments are only embodiments of a part of the present disclosure, rather than all of the embodiments. Based on the embodiments in the present disclosure, all other embodiments obtained by those of ordinary skill in the art without requiring inventive labor, belong to the scope of protection of the present disclosure.

One evaluation scheme for communication performance metrics of a cellular module may be implemented based on conventional instruments (e.g., a graphical sampling multimeter for recording current and voltage, or, a computer for recording log messages with time stamps, etc.), which may be used to evaluate (or analyze) communication performance metrics with respect to, for example, energy consumption or communication latency. However, these conventional instruments can only be used in the laboratory, and they are bulky and inconvenient to carry, therefore, they are difficult to deploy at some application sites. In addition, communication performances of the cellular module may be significantly different in different application scenarios (e.g., in a factory or in a running vehicle) caused by multiple factors (e.g., coverage, manufacturer, operator, or reconnection, etc.), which means that the monitoring and evaluation of the communication performance metrics using the conventional instruments only in the laboratory is not sufficient, and the accuracy of the evaluation result is not high enough.

Another evaluation scheme for communication performance metrics of a cellular module may be implemented based on a portable power analyzer. Such a portable power analyzer may have portability, i.e. may be used in different application scenarios. However, portable power analyzers are relatively costly and can only evaluate power-related communication performance metrics (e.g., energy consumption), i.e., the types of communication performance metrics that can be evaluated are relatively limited. Moreover, another major drawback of the portable power analyzer is that the duration of the evaluation and recording can be limited by the storage space of the storage it comprises.

Moreover, both of the above schemes, in addition to being relatively limited in the types of targeted communication performance metrics and in the application scenarios, the parameters or configuration of these devices have to be manually set and adjusted to effect the evaluation and recording of the communication performance metrics, which is time-consuming. In addition, the above-described schemes also fail to support recording of locations of the cellular module (e.g., applied to a movement scenario, and may be used to record in association with communication performance metrics evaluated at respective locations).

Therefore, in order to overcome the problems existing with the above two schemes, the present application proposes a scheme for automatically evaluating communication performance metrics of a cellular module based on cloud services and a small low-cost monitor.

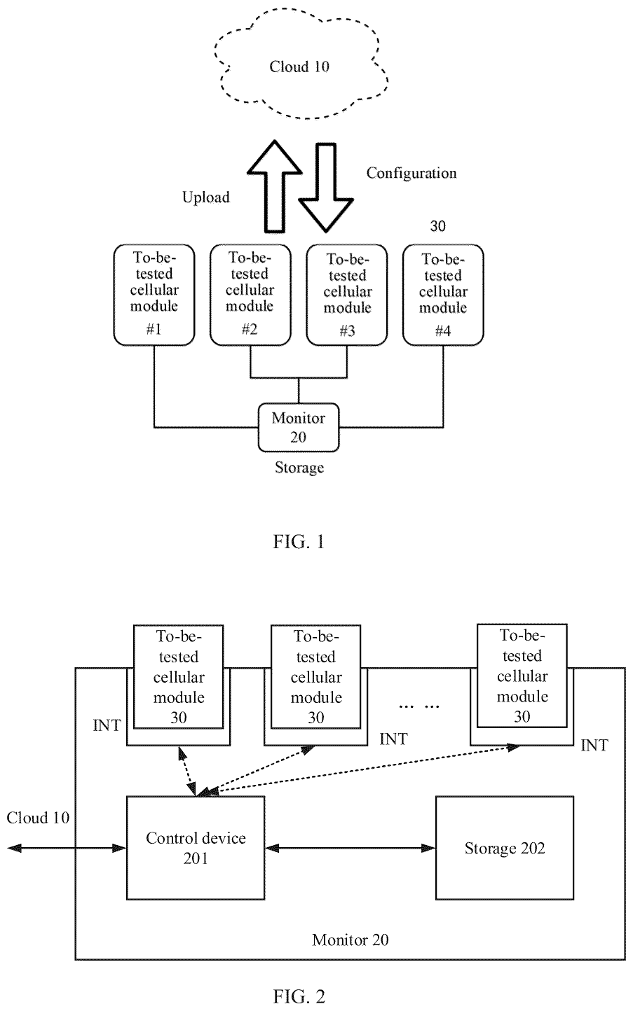

The solution for evaluating communication performance metrics of a cellular module of the present application is described in detail below in connection with FIGS. 1-8.

FIG. 1 shows a schematic diagram of a system for determining (e.g., evaluating) communication performance metrics of a cellular module according to an embodiment of the present application.

As shown in FIG. 1, a system 100 includes cloud 10, a monitor 20, and one or more to-be-tested cellular modules 30 (shown as 4 cellular modules, but not limited thereto).

The cloud 10 may be used to provide cloud services, such as generating configuration information, analyzing and processing data, issuing firmware updates for the monitor 20, and so forth.

The monitor 20 may be a small, low-power embedded system (e.g., based on a microcontroller (MCU), microprocessor, digital processing circuit (DSP), etc.) and may be powered by a power supply (e.g., a battery module) so that portability may be achieved.

The monitor 20 may have an ability to communicate with the cloud, but may or may not communicate with the cloud when actually used, depending on actual situations (e.g. different application scenarios or communication link states). The monitor 20 may be configured remotely based on configuration information obtained from the cloud 10, and the configuration information may include information related to the cellular module to be evaluated (i.e., the cellular module to be monitored or tested, also referred to as “to-be-tested cellular module” herein for brevity) and a type(s) of a communication performance metric(s) (e.g., cellular connection success rate (e.g., a cellular module-cloud connection success rate), cellular base station information, or upload success rate of a specific type of application data, communication quality handoff events, etc., in addition to the energy consumption, end-to-end reliability, and communication latency as described above), and the like. That is, the monitor 20 may evaluate a plurality of types of communication performance metrics, and which communication performance metrics of which cellular module to be evaluated may be indicated by the configuration information.

Optionally, before the monitor 20 obtains the configuration information from the cloud 10, the monitor 20 scans for one or more cellular modules that are present to determine which cellular module can connect with a base station to enable connection to the cloud 10, and, once the monitor 20 is connected to the base station (cloud 10) via a cellular module 30, the monitor 20 obtains the configuration information from the cloud 10 via that cellular module 30. In some cases, the monitor 20 is unable to obtain the configuration information from the cloud, and the configuration information for the monitor 20 may be hard-coded locally in advance (set in advance in a firmware of the monitor 20) so that the monitor 20 can obtain the hard-coded configuration information locally instead of obtaining via the cloud.

The monitor 20 may acquire communication-related data of a specified predetermined communication performance metric(s) of the to-be-tested cellular module based on the configuration information, and after acquiring the communication-related data, determine the predetermined communication performance metric(s) based on at least some of the acquired communication-related data, and may upload the determined predetermined communication performance metric(s) to the cloud 10. For example, the monitor 20 may upload the determined predetermined communication performance metric(s) to the cloud 10 via the currently connected to-be-tested cellular module 30, such that no additional configuration of the communication link between the monitor 20 and the cloud 10 is required. Alternatively, if a network connection between the to-be-tested cellular module 30 and the cloud 10 is not available, the monitor 20 may store the determined predetermined communication performance metric(s) first, such that when a network connection is available later, the monitor 20 may upload the determined predetermined communication performance metric(s) to the cloud 10 via the connected to-be-tested cellular module 30.

In addition, in other embodiments, considering the limited processing capability of the processing component (e.g., a MCU or the control device described later) in the embedded system of the monitor 20, for certain types of communication performance metrics, the monitor 20 may not be able to process the obtained corresponding communication-related data to enable performance evaluation, in which case the monitor 20 may upload the communication-related data for determining the certain types of communication performance metrics to the cloud 10 (e.g., via the connected to-be-tested cellular module 30, as previously described), and then the cloud 10 then evaluates and records the communication performance metrics. In this way, processing capability requirements as well as storage capability requirements at the monitor 20 may be reduced.

The various components included in a system for evaluating communication performance metrics of a cellular module and their associated operations are described above in connection with FIG. 1. In such an evaluation scheme, the monitor may be small and low-cost, have portability, and may automatically evaluate and record predetermined communication performance metrics of the cellular module according to the configuration information. In addition, since the determined communication performance metrics or communication-related data can be uploaded to the cloud, the requirements on the storage space of the storage and the processing capability at the monitor may be reduced.

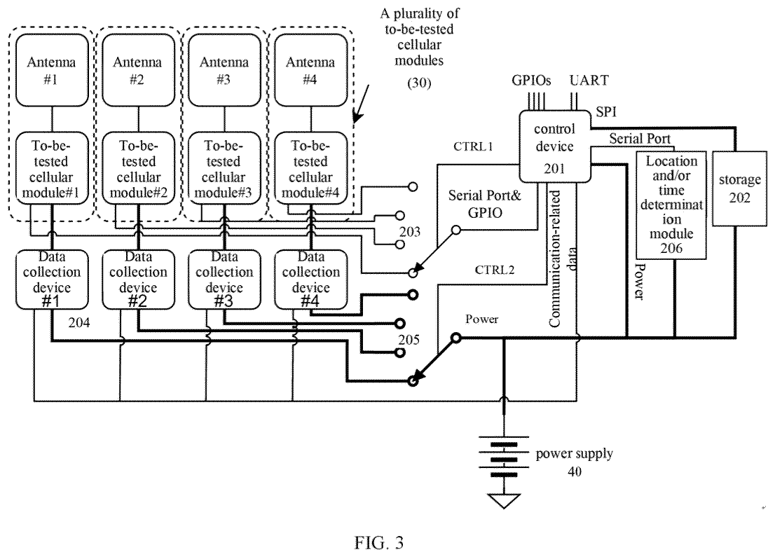

FIG. 2-FIG. 3 each show more details of the system shown in FIG. 1, in which the internal structure of the monitor 20 is shown. The monitor 20 may draw power from a power supply 40 (e.g., a battery). For example, the power supply 40 may power various components within the monitor 20. A power supply, such as a battery, may be included in the monitor 20 or may be external to the monitor 20.

As shown in FIG. 2, the monitor 20 may include a control device 201 (e.g., a microcontroller (MCU), microprocessor, or digital processing circuit (DSP), etc.) as the processing apparatus and a storage 202 (e.g., a secure digital (SD) memory card). It should be understood that the storage 202 refers herein to an external storage of the control device 201, while the control device 201 may also have a storage inside it. The control device 201 may include a port or an interface (such as a serial peripheral interface (SPI)) electrically connected with the external storage 202, so that data of respective communication performance metrics or communication-related data may be written to the external storage or read therefrom for uploading to the cloud.

The control device 201 is configured to implement the main functions of the monitor 20, e.g. have the capability to monitor, record and/or process communication-related data relating to each of various communication performance metrics for determining respective communication performance metrics. The control device 201 may be configured to obtain communication-related data (e.g. from a to-be-tested cellular module or a data acquisition device associated with the to-be-tested cellular module), and determine and record a predetermined communication performance metric(s) of the to-be-tested cellular module based on the communication-related data, or record the communication-related data for determining the predetermined communication performance metric(s), and upload to the cloud, via the to-be-tested cellular module, the predetermined communication performance metric(s) or the communication-related data for determining the predetermined communication performance metric(s) in a case where data is required and is able to be uploaded to the cloud. The storage 202 may be configured to store the predetermined communication performance metric(s) or the communication-related data for determining the predetermined communication performance metric(s) in a case where the control device 201 does not need or cannot upload the predetermined communication performance metric(s) or the communication-related data for determining the predetermined communication performance metric(s) to the cloud and the storage space is not full.

Optionally, as shown in FIGS. 2-3, the monitor 20 may include a cellular interface INT, where the cellular interface is used to electrically connect the monitor 20 with the to-be-tested cellular module 30 so that the monitor can communicate data with the to-be-tested cellular module 30. When there are a plurality of to-be-tested cellular modules 30, a plurality of cellular interfaces may be accordingly included. It is explained in the present application by taking that the monitor may be electrically connected with only one to-be-tested cellular module at a time as an example. It should be understood, however, that if a parallel processing capability of the monitor is sufficient, there are enough input and output ports and a power supply capability of the power supply 40 is sufficient, it is also possible to electrically connect the monitor with a plurality of to-be-tested cellular modules at the same time to evaluate the communication performance metrics of the plurality of to-be-tested cellular modules at the same time, in which case a selector 203, which will be described below, may be omitted.

The control device 201 may be electrically connected with the cellular interface INT, in turn connected to the to-be-tested cellular module 30. For example, the control device 201 may include a plurality of input/output (I/O) ports (shown as GPIO) for connecting with the cellular interface INT, so as to connect to a corresponding I/O port of the to-be-tested cellular module 30, which may enable data communication of the control device 201 with the to-be-tested cellular module 30.

Optionally, as mentioned earlier, there may be a plurality of cellular interfaces, i.e. there may be a plurality of to-be-tested cellular modules 30, but in the present application it is exemplified that the monitor 20 can evaluate only one to-be-tested cellular module at a time, so in this case the monitor 20 may also comprise a selector 203 (e.g. a switching circuit such as a plurality of switches or a multiplexer MUX, etc.). The selector 203 may connect the control device 201 with a corresponding cellular interface of the plurality of cellular interfaces, and in turn to a corresponding to-be-tested cellular module 30, based on a selection control signal (CTRL1) from the control device 201.

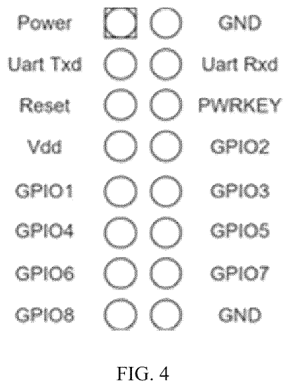

The structure of the cellular interface INT may be as shown in FIG. 4. The cellular interface INT may adopt a unified interface and can accommodate most types of cellular modules, so it is very easy for easy expansion. Currently, most types of cellular modules may be controlled using AT commands on serial ports (i.e. “Uart Rxd” and “Uart Txd”), i.e. the control device 201 may also comprise a plurality of ports (e.g. a serial port for control and a port for data communication (e.g. GPIO), etc.) connected with respective ports of the cellular interface, so that the control device 201 can enable control of and data communication with the to-be-tested cellular module (also having a plurality of ports connected with respective ports of the cellular interface) via the cellular interface through these ports. Optionally, for compatibility, as an example, the cellular interface INT may reserve 8 input/output ports (GPIO).

Optionally, the control device 201 in the monitor may obtain configuration information from the cloud 10 or may obtain the configuration information that is hard-coded in advance and locally, the configuration information indicating at least a type of the predetermined communication performance metric(s) and identification information of the to-be-tested cellular module, so that the control device may obtain communication-related data associated with the to-be-tested cellular module for determining the predetermined communication performance metric(s).

For example, there may be a plurality of to-be-tested cellular modules (electrically connected to a plurality of corresponding cellular interfaces, respectively), and the control device 201 of the monitor 20 has acquired the identification (ID) of each to-be-tested cellular module in turn via the communication/electrical connection between the monitor 20 and the respective to-be-tested cellular modules 10, so after extracting the ID of the to-be-tested cellular module from the configuration information, the control device 201 of the monitor 20 may monitor and evaluate a predetermined to-be-tested cellular module to which the ID of the to-be-tested cellular module corresponds, for example, the control device 201 may generate a selection control signal based on the identification information to control the selector 203 to connect the control device 201 with the corresponding to-be-tested cellular module.

In addition, the type of communication-related data that needs to be acquired by the control device 201 of the monitor 20 may be different for each communication performance metric, but may also be the same and subjected to different processes at the control device 201 of the monitor 20 for different communication performance metrics. That is, different processes (e.g. different algorithms or programs) are provided at the control device 201 of the monitor 20 for communication-related data that is capable of being acquired, so that various communication performance metrics may be determined.

In some cases, the control device 201 may obtain communication-related data from the to-be-tested cellular module 30 (or a data collection device thereof) according to a specified type(s) of a predetermined communication performance metric(s), and may further calculate or analyze the communication-related data to obtain the specified type of the predetermined communication performance metric (or may transmit the communication-related data to the cloud for calculation or analysis). For example, for the cellular connection success rate, the control device 201 may obtain, through AT instructions, communication-related data of whether the cellular module 30 and the base station can successfully establish a connection, thereby calculating the connection success rate; for another example, for a cellular base station ID, the cellular module 30 may determine (e.g., obtain from the cellular base station) cellular base station information (e.g., base station ID, model, or payload, etc.) based on a successful connection with the cellular base station, and the monitor 20 may obtain from the cellular module 30 the cellular base station ID of the cellular base station to which the cellular module 30 has connected; for yet another example, for a communication quality switch event, the control device 201 may determine when a communication quality switch event occurs (e.g., when a train crosses a tunnel) by polling the cellular module 30 to obtain the base station connection status as well as the ID of the connected base station and associating a time and/or location (e.g., obtained by a GPS/GNSS module described later) therewith.

Alternatively, in other cases, after the monitor 20 establishes a connection with the to-be-tested cellular module 30, the control device 201 of the monitor 20 may obtain various communication-related data from the to-be-tested cellular module 30, then filter the desired communication-related data therefrom according to the specified type of the predetermined communication performance metric, and similarly perform the calculation or analysis to obtain the communication performance metric based on the filtered communication-related data associated with the specified type of the predetermined communication performance metric (or transmit the communication-related data to the cloud for calculation or analysis).

In addition, as shown in FIG. 3, the monitor 20 may additionally include a data collection device 204 for collecting other communication-related data of the to-be-tested cellular module 30. For example, a digital electric meter (for example, a device having a small size and a low cost, which outputs a current battery electric amount of the battery module after an input signal is computationally processed, for example, a Coulomb counter) may be provided to collect energy consumption-related data (for example, the battery electric amount) of the to-be-tested cellular module 30, as the communication-related data of the to-be-tested cellular module for the metric of the energy consumption rate, and provide the communication-related data (battery electric amount) to the control device 201.

The data collection device 204 may be connected to the to-be-tested cellular module 30 and to the control device 201 of the monitor 20, such that the data collection device 204 may transmit the collected data relating to the to-be-tested cellular module 30 to the control device 201 for performing evaluation and recording and/or uploading of the data. Optionally, in a case where there are a plurality of cellular interfaces, the monitor may further comprise a second selector 205 (e.g., a switching circuit such as a plurality of switches or a multiplexer MUX, etc.) for electrically connecting the data collection device with a corresponding cellular interface of the plurality of cellular interfaces, and in turn to a corresponding to-be-tested cellular module 30 so that data related to the corresponding to-be-tested cellular module may be collected, and for electrically connecting the data collection device 204 with the control device 201. In addition, if data collection devices are in one-to-one correspondence with the plurality of cellular interfaces, the second selector 205 enables or activates a corresponding data collection device (for example, connects the power supply 40 to the corresponding data collection device) in response to a second selection control signal CTRL2 of the control device 201. Further, only one data collection device is shown for each to-be-tested cellular module in the drawings, and two or more data collection devices may be provided for each to-be-tested cellular module depending on the type and number of the predetermined communication performance metric(s).

Optionally, the monitor 20 may also comprise a location and/or time determination module 206, e.g. a GPS/GNSS module. The location and/or time determination module 206 may be configured to determine a location and/or time at which each piece of communication-related data is acquired, so that the control device 201 may record (e.g. cache or store) each piece of communication-related data or the evaluated communication performance metric in association with a corresponding location and/or time, e.g., in a form of a list. Optionally, the control device 201 may include a port or interface (such as a serial port) electrically connected with an external storage, so that location and/or time information may be acquired from the location and/or time determination module. In some cases, if only time information is required, this location and/or time determination module 206 may not be provided, but the time information is provided to the control device 201 by the to-be-tested cellular module 30, for example, the to-be-tested cellular module implements clock synchronization based on communication with the cellular base station, so that accurate time can be derived.

Optionally, the configuration information may also include one or more of: a condition for stopping monitoring (e.g., a duration of each monitoring and evaluation operation), a threshold number of experiments (a preset number of times to conduct experiments against the predetermined communication performance metric), an indication of whether location and/or time information is required, whether to start the monitoring and evaluation operation immediately, or whether to upload data to the cloud, and the like.

For example, based on configuration information obtained from the cloud (e.g., when cloud services are fully available) or locally hard-coded (e.g., when at least a part of cloud services are unavailable), after the control device 201 starts to monitor a predetermined communication performance metric of a certain to-be-tested cellular module, i.e., starts to acquire communication-related data, if the control device 201 determines that the condition for stopping monitoring is met (e.g., the monitoring has lasted enough time), and data is required to be uploaded to the cloud (e.g., which may be determined based on the configuration information), the control device 201 may, based on an available network connection between the to-be-tested cellular module and the cloud, upload, to the cloud and via the to-be-tested cellular module, the determined predetermined communication performance metric or acquired communication-related data for determining the predetermined communication performance metric. Alternatively, if the control device 201 determines that the condition for stopping monitoring is met but data is not required to be uploaded to the cloud, and storage space of the storage is not full, the predetermined communication performance metric or the acquired communication-related data for determining the predetermined communication performance metric is stored in the storage. Alternatively, if the control device 201 determines that the condition for stopping monitoring is met but data is not required to be uploaded to the cloud, and the storage space of the storage is full, the predetermined communication performance metric or the acquired communication-related data for determining the predetermined communication performance metric is uploaded to the cloud based on an available network connection between the to-be-tested cellular module and the cloud, even if it has been determined that data is not required to be uploaded to the cloud according to the configuration information (and the control device 201 may stop working if there is no available network connection). Alternatively, if the control device 201 determines that the condition for stopping monitoring is met and data cannot be uploaded to the cloud (but the configuration information indicates that data is required to be uploaded to cloud), when the storage space of the storage is not full, the predetermined communication performance metric or the acquired communication-related data for determining the predetermined communication performance metric is stored in the storage (the data may be uploaded to the cloud after the network connection is resumed), and when the storage space of the storage is full, the control device 201 may stop working. Alternatively, the control device 201 may determine whether a network connection between the to-be-tested cellular module and the cloud is available, so to determine whether the ability of the control device to upload data to the cloud is available, which may be determined based on the communication of the control device 201 with the to-be-tested cellular module.

In other cases, cloud services are unavailable or partially unavailable such that the configuration information cannot be obtained from the cloud, the locally hard-coded configuration information may include an explicit indication that data is not required to be uploaded to the cloud (i.e., the cloud service is unavailable), or may not include the indication to implicitly indicate that the cloud services are unavailable (i.e., no data is not required to be uploaded to the cloud), such that the control device 201 may determine from the configuration information that data is not required to be uploaded to the cloud. Additionally or alternatively, the control device 201 may determine that a network connection between the to-be-tested cellular module and the cloud is unavailable such that data cannot be uploaded to the cloud (e.g., in an application scenario where energy consumption rate for weak coverage is evaluated). In this case, the control device 201 may be further configured to: in a case where it is determined that the condition for stopping monitoring is met, and the storage space of the storage is not full, store the predetermined communication performance metric or the acquired communication-related data for determining the predetermined communication performance metric to the storage; and/or in a case where it is determined that the condition for stopping monitoring is met, and the storage space of the storage is full, the control device 201 may stop working.

Alternatively, as previously mentioned, the operations performed by the control device 201 described above involve data uploading and storing, where each process in which the control device 201 obtains (e.g. completes record of) data (e.g., the predetermined communication performance metric or communication-related data for determining the predetermined communication performance metric) to be uploaded or stored may be regarded as an experiment during the monitoring and evaluation for the predetermined communication performance metric. In this case, the configuration information may further comprise a threshold number of experiments, so that the control device 201 may further perform the following operations: updating current experiment count each time an experiment is completed; checking the current experiment count each time data is uploaded to the cloud; and in a case where the current experiment count reaches the threshold number of experiments, i.e. for the predetermined communication performance metric of the to-be-tested cellular module currently specified in current configuration information, sufficient communication performance metrics or communication-related data for determining the same have been acquired (i.e., these pieces of data have been uploaded or stored), accuracy can already be guaranteed. If the cloud services are available, new configuration information may be acquired from the cloud, such that next round of monitoring and evaluation for another predetermined communication performance metric corresponding to the newly acquired configuration information may be conducted according to the newly acquired configuration information. If cloud services are not available, new configuration information cannot be obtained from the cloud (the present application defaults to the two means of obtaining configuration information (i.e., from the cloud and locally hard-coded in advance) are exclusive, so there is no hard-coded configuration information in this case), so the control device 201 stops working.

Similarly, the control device 201 may also perform the following operations: updating the current experiment count each time an experiment is completed; checking the current experiment count each time the storage stores data, and in a case where the current experiment count reaches the threshold number of experiments, uploading to the cloud the predetermined communication performance metric or communication-related data for determining the predetermined communication performance metric based on an available network connection between the to-be-tested cellular module and the cloud. If data cannot be uploaded to the cloud (e.g., the network connection between the to-be-tested cellular module and the cloud is not available), the control device 201 stops working.

In this way, with respect to the predetermined communication performance metric (e.g., connection success rate), the control device 201 may record multiple pieces of data of the predetermined communication performance metric or associated communication-related data and upload them to the cloud or store them into a storage, which may improve the accuracy of the resulting evaluation result.

Details of the various components comprised by the system for evaluating communication performance metrics of a cellular module and their associated operations are described above based on FIGS. 2-4, and such a system may be adapted to most types of cellular modules in addition to the previously described benefits, and thus an adaptability of the system is high. Since the location and/or time determination module is also optionally provided, each piece of communication-related data or the evaluated communication performance metric may be recorded in association with a corresponding location and/or time, which may in turn make the recorded communication performance metrics clearer and more comprehensive. The communication performance metrics and/or communication-related data may be available for uploading to the cloud for the cloud to obtain more information based on the analysis on the communication performance metrics or communication-related data at different locations and/or times in conjunction with the different locations and/or times. In addition, appropriate processing (uploading or storing) of the evaluated communication performance metric or communication-related data may be selected based on factors such as cloud capability and storage capability and/or network connection of the monitor, which may enhance system adaptability.

To better describe the operations performed by the control device of the monitor, in conjunction with the foregoing description of the system for evaluating the communication performance metrics, the following specifically describes processes of the control device 201 for evaluating the communication performance metrics of the to-be-tested cellular module in different situations. It should be noted that the following is merely by way of example and not limitation for all situations. For example, the different situations may include the following three situations:
Situation 1—the control device is able to obtain configuration information from the cloud (the cloud normally provides services) and is able to upload data to the cloud (e.g., network connection between the to-be-tested cellular module and the cloud is available);
Situation 2—the control device is unable to obtain configuration information from the cloud, but is able to upload data to the cloud (cloud services are partially available and network connection between the to-be-tested cellular module and the cloud is available); and
Situation 3—the control device is unable to obtain configuration information from the cloud, and is unable to upload data to the cloud (network connection between the to-be-tested cellular module and the cloud is not available, no matter whether cloud services are available or not).

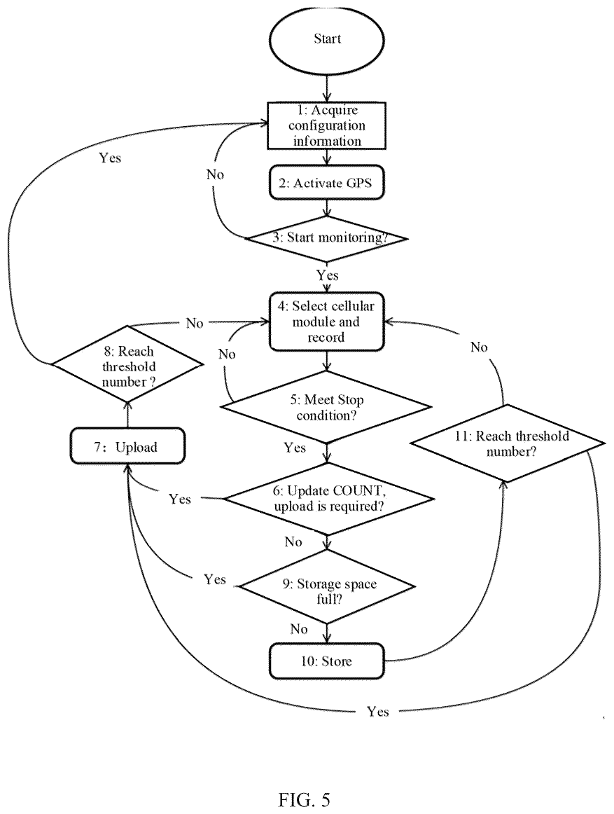

FIG. 5 illustrates a schematic diagram of processes of evaluating communication performance metrics of a to-be-tested cellular module performed by the control device 201 under Situation 1 according to an embodiment of the present application.

As shown in FIG. 5, in process 1, the control device 201 may acquire configuration information from the cloud. For example, one or more cellular modules currently existing may be scanned as previously described, so that the configuration information may be obtained via one of these cellular modules capable of communicating with the cloud. Alternatively, this configuration information may be in a form of .json file. The configuration information may specify the to-be-tested cellular module and the type of the predetermined communication performance metric to be evaluated and recorded, and may specify one or more of: a condition for stopping monitoring (e.g., a duration of each monitoring and evaluation operation), a threshold number of experiments (a preset number of times to conduct experiments against the predetermined communication performance metric), an indication of whether location and/or time information is required, or whether to upload data to the cloud, and the like.

In process 2, as an optional process, if location and/or time information is required (determined, for example, based on the configuration information), the control device 201 may transmit a control signal to the location and/or time module to enable or activate the module (e.g., a GPS module); otherwise, the control signal is not transmitted, i.e. the location and/or time module is turned off, so that power consumption may be reduced and endurance of the monitor 20 may be extended.

In process 3, the control device 201 may determine whether to start the monitoring and evaluation operation, e.g., start the operation in response to a received start command (e.g., a start command generated based on a user operation or a start command generated based on timing information in the configuration information).

In process 4, when starting the monitoring and evaluation operation, the control device 201 may start acquiring communication-related data based on the to-be-tested cellular module and the type of the predetermined communication performance metric determined from the configuration information, and evaluate and record the predetermined communication performance metric, or record the communication-related data for evaluating the predetermined communication performance metric and upload the acquired communication-related data for evaluating the predetermined communication performance metric to the cloud in a subsequent process 7.

In process 5, whether the condition for stopping monitoring is met is determined. When the condition for stopping monitoring is met, i.e. the control device 201 has performed the monitoring and evaluation operation for a predetermined duration or received a stop command (e.g. generated based on a user operation or generated based on timing information in the configuration information), an experiment count (COUNT) is updated in process 6 and it is determined whether data is required to be uploaded to the cloud (in this situation the network connection (e.g. via a cellular base station) between the to-be-tested cellular module and the cloud is available), e.g. determined based on the configuration information.

If the judgment result in process 6 is “YES”, the control device 201 may upload, in process 7, the recorded predetermined communication performance metric or communication-related data for evaluating the predetermined communication performance metric to the cloud via the to-be-tested cellular module. Optionally, a threshold number of experiments may also be configured in the configuration information, therefore, in process 8, it is judged whether the current experiment count reaches the threshold number of experiments, if yes, the control device 201 may return to the process 1 to acquire new configuration information, otherwise start the monitoring and evaluation operation again to conduct a new experiment, i.e., return to process 4.

If the judgment result in process 6 is “NO”, it is judged in process 9 whether the storage space of a storage is full, and if not, the control device 201 may store the recorded data (the predetermined communication performance metric or the communication-related data for determining the predetermined communication performance metric) in the storage in process 10, check the current experiment count and determine whether the current experiment count reaches the threshold number of experiments in process 11, and if the threshold number of experiments is not reached (i.e., the count is not expired), start the monitoring and evaluation operation again to perform a new experiment, i.e., return to process 4.

If the storage space is judged to be full in process 9, since the network connection between the to-be-tested cellular module and the cloud is available in Situation 1, in order to avoid data loss, the control device 201 may also proceed to upload the recorded data to the cloud via the to-be-tested cellular module in process 7. If it is judged in process 11 that the current experiment count reaches the threshold number of experiments, the control device 201 may also proceed to upload the recorded data to the cloud via the to-be-tested cellular module in process 7 or skip processes 7 and 8, and then return to process 1 so as to obtain new configuration information.

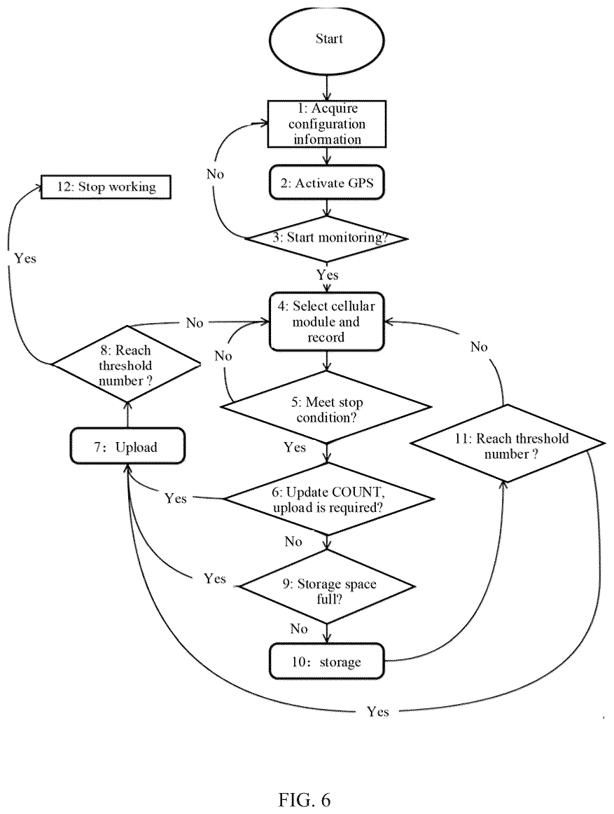

FIG. 6 illustrates a schematic diagram of processes of evaluating communication performance metrics of a to-be-tested cellular module performed by the control device 201 under Situation 2 according to an embodiment of the present application.

In this situation, the control device 201 cannot acquire the configuration information from the cloud, and thus may acquire the configuration information locally hard-coded in process 1, for example, the configuration information may be default configuration information set in advance, or the control device 201 may receive user-coded configuration information after outputting a reminder message that the configuration information cannot be acquired from the cloud. Similarly, the configuration information may be in the form of .json file. The configuration information may specify the to-be-tested cellular module and the type of the predetermined communication performance metric to be evaluated and recorded, and may specify one or more of: a condition for stopping monitoring (e.g., a duration of each monitoring and evaluation operation), a threshold number of experiments (a preset number of times to conduct experiments against the predetermined communication performance metric), an indication of whether location and/or time information is required, or whether to upload data to the cloud, and the like.

The processes in FIG. 6 are substantially similar to the processes in FIG. 5, and thus a detailed description thereof is omitted. In FIG. 6, since under Situation 2, the control device 201 cannot acquire configuration information from the cloud, if it is determined in process 8 that current experiment count reaches the threshold number of experiments, the monitoring and evaluation operation is stopped at process 12, otherwise, the control device 201 may continue the monitoring and evaluation operation for a new experiment, i.e., return to process 4.

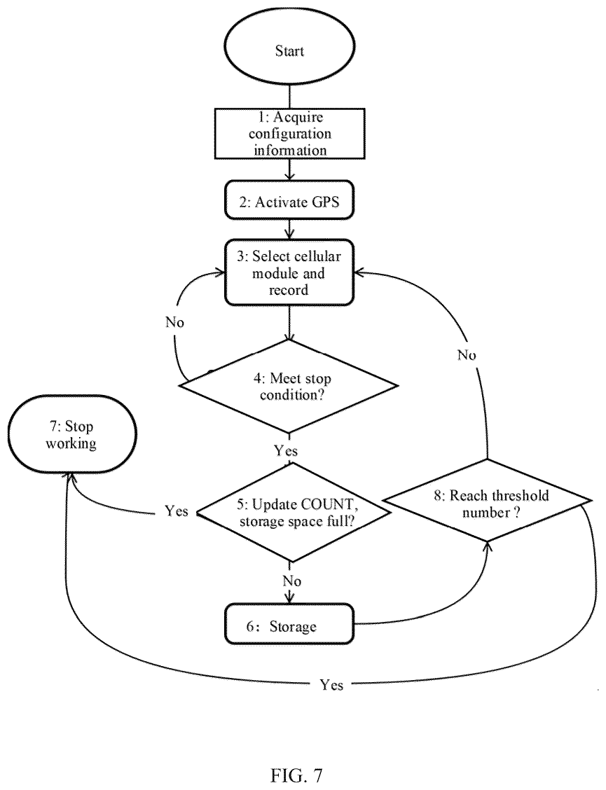

FIG. 7 shows a schematic diagram of processes of evaluating communication performance metrics of a to-be-tested cellular module performed by the control device 201 under Situation 3 according to an embodiment of the present application.

In this situation, the control device 201 cannot acquire the configuration information from the cloud, and thus may acquire the configuration information locally hard-coded in process 1, for example, the configuration information may be default configuration information set in advance, or may receive user-coded configuration information after outputting a reminder message that the configuration information cannot be acquired from the cloud. Similarly, the configuration information may be in the form of .json file. The configuration information may specify the to-be-tested cellular module and the type of the predetermined communication performance metric to be evaluated and recorded, and may specify one or more of: a condition for stopping monitoring (e.g., a duration of each monitoring and evaluation operation), a threshold number of experiments (a preset number of times to conduct experiments against the predetermined communication performance metric), an indication of whether location and/or time information is required, or whether to upload data to the cloud, and the like.

In process 2, as an optional process, if location and/or time information is required (determined, for example, based on the configuration information), the control device 201 may transmit a control signal to the location and/or time module to enable or activate the module; otherwise, the control signal is not transmitted, i.e. the location and/or time module is turned off.

In process 3, the control device 201 may start acquiring communication-related data based on the to-be-tested cellular module and the type of the predetermined communication performance metric determined from the configuration information, and evaluate and record the predetermined communication performance metric, or record the communication-related data for evaluating the predetermined communication performance metric, in response to a start command (for example, a start command generated based on a user operation).

In process 4, when the condition for stopping monitoring is met, i.e., the control device 201 has performed the monitoring and evaluation operation for a predetermined duration or receives a stop command (e.g., a stop command generated based on a user operation), the control device 201 may update the current experiment count in process 5, and further judge whether there is free storage space in the storage since the network connection between the to-be-tested cellular module and the cloud (e.g., via a cellular base station) is not available at this time. If there is free storage space, in process 6, the control device 201 may store, in the storage, the predetermined communication performance metric or the communication-related data for evaluating the predetermined communication performance metric which is recorded.

If it is judged in process 5 that the storage space is full, since the network connection between the to-be-tested cellular module and the cloud is unavailable, the control device 201 may only stop the monitoring and evaluation operation at this time, in process 7.

In addition, in process 8, it is judged whether the current experiment count reaches the threshold number of experiments, and if not (i.e., this monitoring and evaluating operation has been repeated less than a predetermined number of times), the control device 201 may start the monitoring and evaluating operation again to perform a new experiment, i.e., return to process 3; otherwise, the monitoring and evaluation operation is stopped.

Examples of the monitoring and evaluation processes performed at the control device are exemplarily described above for the above three situations. It should be understood that while the various processes are shown in a determined order in these examples, these processes may be performed in a different order and the present disclosure is not limited in this regard.

Accordingly, in accordance with another aspect of the present disclosure, a method for monitoring and evaluating communication performance metrics is provided.

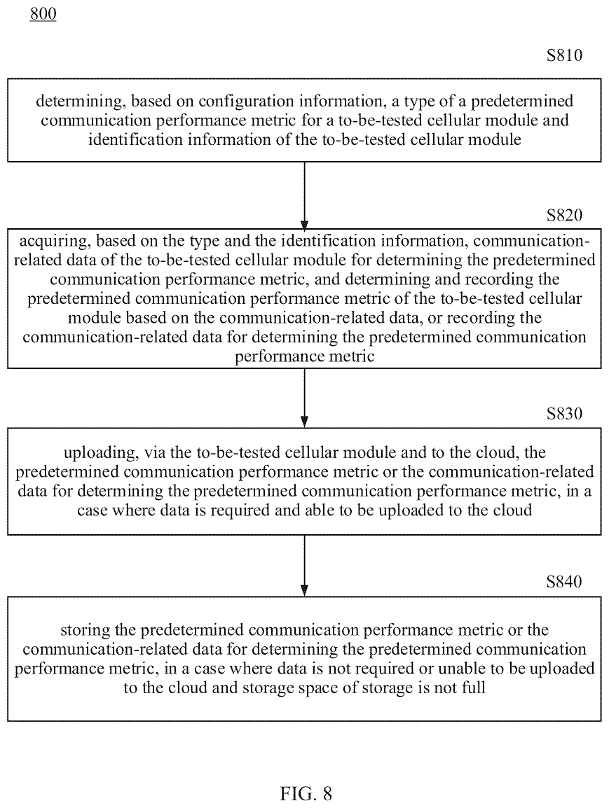

FIG. 8 is a flow diagram illustrating a method for monitoring and evaluating communication performance metrics according to an embodiment of the present disclosure. The method may be performed by a portable device (a monitor as previously described, in particular a control device thereof). The portable device may have an ability to communicate with the cloud and may communicate with the cloud or not under different scenarios. The portable device may have an ability to monitor, record and/or process communication-related data associated with each of a plurality of types of communication performance metrics for determining respective communication performance metrics.

As shown in FIG. 8, in step 810, a type of a predetermined communication performance metric for the to-be-tested cellular module and identification information of the to-be-tested cellular module are determined based on the configuration information.

In step S820, communication-related data, of the to-be-tested cellular module, for determining the predetermined communication performance metric is acquired based on the type and the identification information, and the predetermined communication performance metric of the to-be-tested cellular module is determined and recorded based on the communication-related data, or the communication-related data for determining the predetermined communication performance metric is recorded.

For example, as previously described, the configuration information may specify the to-be-tested cellular module or the type of the predetermined communication performance metrics to be recorded, such that the control device in the monitor may connect to the to-be-tested cellular module and acquire corresponding communication-related data, and evaluate and record the communication performance based on the acquired communication-related data or directly record the communication-related data (in a case where the evaluation operation is performed at the Cloud).

In step S830, the predetermined communication performance metric or the communication-related data for determining the predetermined communication performance metric is uploaded to the cloud via the to-be-tested cellular module, in a case where data is required and able to be uploaded to the Cloud.

In step S840, the predetermined communication performance metric or the communication-related data for determining the predetermined communication performance metric is stored in a storage in a case where data is not required or unable to be uploaded to the Cloud and the storage space is not full.

More details of these steps can be referred to the description of FIGS. 2-7, which are not repeated here.

Accordingly, in accordance with another aspect of the present disclosure, there is also provided a system for monitoring and evaluating communication performance metrics. The system may be the system shown in FIG. 1 and may include: one or more to-be-tested cellular modules; a monitor as previously described with reference to FIGS. 2-7 for communication performance evaluation of each of the one or more to-be-tested cellular modules; and cloud for data communication (e.g., remote configuration and data exchange) with the monitor via one of the one or more to-be-tested cellular modules.

By way of example, the control device of the monitor of the present application may include a processor and a memory which are connected via a system bus, and the monitor may further include a network interface, an input means, and a display screen, among others. The memory may comprise a non-volatile storage medium and an internal memory. The non-volatile storage medium may store an operating system and may also store a computer-executable program that, when executed by the processor, causes the processor to implement various operations as described above and performed by the control device. The internal memory may also have stored therein a computer-executable program which, when executed by the processor, causes the processor to implement various operations as previously described and performed by the control device.

The processor may be an integrated circuit chip having signal processing capabilities. The processor may be a general purpose processor, a digital signal processor (DSP), an application specific integrated circuit (ASIC), an off-the-shelf programmable gate array (FPGA) or other programmable logic device, discrete gate or transistor logic, discrete hardware components. Various methods, steps, and logical block diagrams disclosed in the embodiments of the present application may be implemented or performed through the processor. The general-purpose processor may be a microprocessor or the processor may be any conventional processor or the like and may be of an X84 architecture or an ARM architecture.

The non-volatile memory may be a read-only memory (ROM), a programmable read-only memory (PROM), an erasable programmable read-only memory (EPROM), an electrically erasable programmable read-only memory (EEPROM), or a flash memory. It should be noted that the memory described herein is intended to comprise, without being limited to, these and any other suitable classes of memory.

The display screen may be a liquid crystal display screen or an electronic ink display screen, and the input means may be a touch layer overlaid on the display screen, a button, a trackball or a trackpad provided on a housing of the monitor, an external keyboard, trackpad or mouse, or the like.

It is noted that the flowchart and block diagrams in the drawings illustrate the architecture, functionality, and operation of possible implementations of methods and apparatus according to various embodiments of the present application. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in a reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or operations or combinations of special purpose hardware and computer instructions.

The embodiments of the present application as described in detail above are merely illustrative, but not limiting. It should be understood by those skilled in the art that various modifications and combinations of these embodiments or features thereof may be made without departing from the principles and spirit of the present application, such modifications shall fall within the scope of the present application.

What is claimed is:

1. A portable device for determining communication performance metrics of a cellular module, wherein the portable device has an ability to communicate with cloud and is configured to either communicate with the cloud or not communicate with the cloud under different scenarios, the portable device comprising:
a control device having an ability to monitor, record and/or process communication-related data respectively associated with a plurality of types of communication performance metrics for determining respective communication performance metrics, and is configured to:
determine, based on configuration information, a type of a predetermined communication performance metric and identification information of a to-be-tested cellular module;
acquire, based on the type and the identification information, communication-related data of the to-be-tested cellular module for determining the predetermined communication performance metric, and determine and record the predetermined communication performance metric of the to-be-tested cellular module based on the communication-related data, or record the communication-related data for determining the predetermined communication performance metric; and
upload, via the to-be-tested cellular module and to the cloud, the predetermined communication performance metric or the communication-related data for determining the predetermined communication performance metric, in a case where data is required and able to be uploaded to the cloud; and
a storage for storing the predetermined communication performance metric or the communication-related data for determining the predetermined communication performance metric, in a case where data is not required or unable to be uploaded to the cloud and storage space of the storage is not full.

2. The portable device of claim 1, wherein the control device is further configured to acquire the configuration information from the cloud or use local configuration information set in advance.

3. The portable device of claim 1, wherein the configuration information further comprises an indication of whether the data is required to be uploaded to the cloud and a condition for stopping monitoring, and the control device is further configured to:
upload, via the to-be-tested cellular module and to the cloud, the predetermined communication performance metric or the communication-related data for determining the predetermined communication performance metric, based on an available network connection between the to-be-tested cellular module and the cloud, in response to the condition for stopping monitoring being met and the data being required to be uploaded to the cloud; and/or
store, in the storage, the predetermined communication performance metric or the communication-related data for determining the predetermined communication performance metric, in response to the condition for stopping monitoring being met, the data being not required to be uploaded to the cloud and the storage space of the storage being not full; and/or
upload, via the to-be-tested cellular module and to the cloud, the predetermined communication performance metric or the communication-related data for determining the predetermined communication performance metric, based on the available network connection between the to-be-tested cellular module and the cloud, in response to the condition for stopping monitoring being met, the data being not required to be uploaded to the cloud and the storage space of the storage being full.

4. The portable device of claim 1, wherein the configuration information further includes a condition for stopping monitoring, and the control device is further configured to:
store, in the storage, the predetermined communication performance metric or the communication-related data for determining the predetermined communication performance metric, in response to the condition for stopping monitoring being met and the storage space of the storage being not full; and/or
stop working, in response to the condition for stopping monitoring being met and the storage space of the storage being full.

5. The portable device of claim 3, wherein the configuration information further comprises a threshold number of experiments, and an operation completed by the control device for recording the predetermined communication performance metric or the communication-related data for determining the predetermined communication performance metric is as one experiment, and wherein the control device is further configured to:
update current experiment count, in response to the condition for stopping monitoring being met;
check the current experiment count each time data is uploaded to the cloud, and in response to the current experiment count reaching the threshold number of experiments, acquire new configuration information from the cloud in a case where cloud services are available or stop working in a case where cloud services are unavailable; and/or
check the current experiment count each time after the storage stores data, and in response to the current experiment count reaching the threshold number of experiments, upload, via the to-be-tested cellular module and to the cloud, the predetermined communication performance metric or the communication-related data for determining the predetermined communication performance metric based on the available network connection between the to-be-tested cellular module and the cloud, or stop working in an absence of the available network connection.

6. The portable device of claim 4, wherein the configuration information further comprises a threshold number of experiments, and an operation completed by the control device for recording the predetermined communication performance metric or the communication-related data for determining the predetermined communication performance metric is as one experiment, and wherein the control device is further configured to:
update current experiment count, in response to the condition for stopping monitoring being met;
check the current experiment count each time data is uploaded to the cloud, and in response to the current experiment count reaching the threshold number of experiments, acquire new configuration information from the cloud in a case where cloud services are available or stop working in a case where cloud services are unavailable; and/or
check the current experiment count each time after the storage stores data, and in response to the current experiment count reaching the threshold number of experiments, upload, via the to-be-tested cellular module and to the cloud, the predetermined communication performance metric or the communication-related data for determining the predetermined communication performance metric based on the available network connection between the to-be-tested cellular module and the cloud, or stop working in an absence of the available network connection.

7. The portable device of claim 2, wherein the to-be-tested cellular module is one of a plurality of cellular modules, and the portable device further comprises:
a plurality of cellular interfaces for installing and connecting the plurality of cellular modules, respectively, and having a connection ability with the control device; and
a selector for connecting the control device with the to-be-tested cellular module via a corresponding cellular interface of the plurality of cellular interfaces according to a selection control signal from the control device,
wherein the control device is configured to generate the selection control signal based on the identification information of the to-be-tested cellular module and determine the communication-related data for determining the predetermined communication performance metric of the to-be-tested cellular module based on the type of the predetermined communication performance metric.

8. The portable device according to claim 1, wherein the portable device further comprises a location and/or time determination module for determining a location and/or monitoring time of the to-be-tested cellular module, and
wherein the control device is further configured to obtain the location and/or monitoring time and to associate the predetermined communication performance metric or the communication-related data for determining the predetermined communication performance metric with a corresponding location and/or monitoring time.

9. The portable device of claim 1, wherein the predetermined communication performance metric comprises an energy consumption rate, and the portable device further comprises:
a digital electric meter connected with the to-be-tested cellular module as well as a battery module, and is configured to measure battery electric amount data of the battery module as the communication-related data of the to-be-tested cellular module, and provide the battery electric amount data to the control device,
wherein the battery module is configured to provide power to the to-be-tested cellular module and the portable device.

10. The portable device of claim 1, wherein the predetermined communication performance metric comprises a cellular module-cloud connection success rate, a cellular base station identification, or a data upload success rate,
wherein the control device is configured to receive the communication-related data from the to-be-tested cellular module, the communication-related data comprising data related to communication of the to-be-tested cellular module with a cellular base station.

11. A method performed by a portable device for determining communication performance metrics of a cellular module, wherein the portable device has an ability to communicate with cloud and is configured to either communicate with the cloud or not communicate with the cloud under different scenarios and has an ability to monitor, record and/or process communication-related data respectively associated with a plurality of types of communication performance metrics for determining respective communication performance metrics, the method comprising:
determining, based on configuration information, a type of a predetermined communication performance metric for a to-be-tested cellular module and identification information of the to-be-tested cellular module;
acquiring, based on the type and the identification information, communication-related data of the to-be-tested cellular module for determining the predetermined communication performance metric, and determining and recording the predetermined communication performance metric of the to-be-tested cellular module based on the communication-related data, or recording the communication-related data for determining the predetermined communication performance metric;
uploading, via the to-be-tested cellular module and to the cloud, the predetermined communication performance metric or the communication-related data for determining the predetermined communication performance metric, in a case where data is required and able to be uploaded to the cloud; and
storing the predetermined communication performance metric or the communication-related data for determining the predetermined communication performance metric, in a case where data is not required or unable to be uploaded to the cloud and storage space of a storage is not full.
